(19) United States
(12) Patent Application Publication
(10) Pub. No.: US 2025/0290600 A1
(43) Pub. Date: Sep. 18, 2025

(54) PRESSURE VESSEL

(71) Applicants: HYUNDAI MOTOR COMPANY, Seoul (KR); Kia Corporation, Seoul (KR)

(72) Inventor: Chan Jin KIM, Hwaseong-si (KR)

(73) Assignees: HYUNDAI MOTOR COMPANY, Seoul (KR); Kia Corporation, Seoul (KR)

(21) Appl. No.: 18/888,710

(22) Filed: Sep. 18, 2024

(30) Foreign Application Priority Data
Mar. 12, 2024 (KR) 10-2024-0034566

(51) Int. Cl. F17C 1/06

(52) U.S. Cl. CPC F17C 1/06; F17C 2201/0109; F17C 2203/0604; F17C 2203/067

(57) ABSTRACT

A pressure vessel includes a liner configured so that a pressure is applied to an internal surface of the liner, and a composite material surrounding an external surface of the liner.

### CROSS-REFERENCE TO RELATED APPLICATION

The present application claims priority to Korean Patent Application No. 10-2024-0034566, filed on Mar. 12, 2024, the entire contents of which is incorporated herein for all purposes by this reference.

### BACKGROUND OF THE PRESENT DISCLOSURE

### Field of the Present Disclosure

The present disclosure relates to a pressure vessel.

### Description of Related art

A pressure vessel, in which a fluid of a high pressure is accommodated, is designed to withstand an internal pressure load by stacking reinforcing layers in the vessel by applying a filament winding process. To efficiently design such a pressure vessel, a continuous fiber composite material which is an anisotropic material has to be arranged along various directions.

The continuous fiber composite materials are laminated through polar winding or helical winding to reinforce a dome portion of the liner. In the winding for reinforcing the dome portion like this, when a reinforcement pole of the dome portion is designated, an orientation angle of the composite materials that surround the cylinder portion is determined.

In a conventional pressure vessel, when the winding is performed based on the reinforcement point of the designated dome portion, a thickness of the composite material becomes thicker as it goes from the cylinder portion to the dome portion. Due to the present phenomenon, in which the thickness of the composite material becomes thicker as it goes from the cylinder portion to the dome portion, some areas of the composite material disposed in the dome portion have more bands than necessary, which are stacked on each other. In the present way, when a relatively large number of bands are stacked on the dome portion compared to the cylinder portion, two adjacent layers are crushed and an irregular shape is caused whereby stress is concentrated and a performance of the composite material which is stacked at the front and rear ends deteriorates as tensions of the layers that constitutes the composite material are accumulated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a pressure vessel that minimizes concentration of stress due to crushing of two adjacent ones of a plurality of layer and an irregular shape, and deterioration of a performance of front and rear layers.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a pressure vessel includes a liner configured so that a pressure is applied to an internal surface of the liner, and a composite material surrounding an external surface of the liner, the liner includes a cylinder portion defining a central area of the external surface of the liner, and a dome portion connected to opposite sides of the cylinder portion in a longitudinal direction of the pressure vessel, when an imaginary straight line passing through a center portion of the liner and extending in the longitudinal direction is defined as a reference straight line, the composite material includes a plurality of helical layers including a plurality of unit bands having an annular shape surrounding the cylinder portion and the dome portion, two arbitrary ones of the plurality of helical layers are defined as a first helical layer and a second helical layer, respectively, and a plurality of unit bands provided in the first helical layer are defined as a plurality of first unit bands and a plurality of unit bands provided in the second helical layer are defined as a plurality of second unit bands, the first unit bands include a first cylinder layer area being an area surrounding the cylinder portion, and the second unit bands include a second cylinder layer area being an area surrounding the cylinder portion, and a size of an angle defined by the first cylinder layer area and the reference straight line, and a size of an angle defined by the second cylinder layer area and the reference straight line are different.

Furthermore, sizes of angles defined by the first cylinder layer areas provided in the plurality of first unit bands, respectively, and the reference straight line may be the same, and sizes of angles defined by the second cylinder layer areas provided in the plurality of second unit bands, respectively, and the reference straight line may be the same.

Furthermore, the first cylinder layer areas provided in the plurality of first unit bands, respectively, may include a first cross area having a shape, in which two different first unit bands cross each other, and wherein when a direction being perpendicular to the reference straight line is defined as a radial direction, a thickness of the first cylinder layer area in the radial direction may be less than or equal to cylinder thicknesses being thicknesses of two different first unit bands of the first cross area in the radial direction.

Furthermore, a plurality of first cross areas may be provided, and the first cylinder layer area may further include a first extension area extending between first and second adjacent ones of the plurality of first cross areas.

Furthermore, each of the first unit bands may further include a first dome layer area surrounding an external surface of the dome portion, and the first dome layer area may include a first ring area, when one side of the dome portion in the longitudinal direction is viewed in parallel to the longitudinal direction, having an annular shape surrounding the reference straight line.

Furthermore, each of the second unit bands may further include a second dome layer area surrounding an external surface of the dome portion, the second dome layer area may include a second ring area, when one side of the dome portion in the longitudinal direction is viewed in parallel to the longitudinal direction, having an annular shape surrounding the reference straight line, and when a direction being perpendicular to the reference straight line is defined as a radial direction, and when a size of an angle defined by the first cylinder layer area and the reference straight line is greater than a size of an angle defined by the second cylinder layer area and the reference straight line, a spacing distance between the first ring area and the reference straight line in the radial direction may be greater than a spacing distance between the second ring area and the reference straight line in the radial direction.

Furthermore, when a direction, in which a pressure is applied to an internal surface of the dome portion is defined as a pressing direction, and an opposite direction to the pressing direction is defined as an opposite pressing direction, when a thickness, in the pressing direction, of an area, of which a spacing distance, in the pressing direction, between an end portion of the first dome layer area in the pressing direction and an end portion of the first dome layer area in the opposite pressing direction, is largest is defined as a first dome thickness, and when a thickness, in the radial direction, of an area, of which a spacing distance, in the radial direction, between an end portion of the first cylinder layer area in the radial direction, and an end portion of the first cylinder layer area in an opposite direction to the radial direction is largest is defined as a first cylinder thickness, the first dome thickness may be less than or equal to twice the first cylinder thickness.

Furthermore, the liner may further include a connection portion connecting the cylinder portion and the dome portion, and when one side of the liner in the longitudinal direction is viewed in parallel to the longitudinal direction, the first ring area may be located in the connection portion.

Furthermore, when the first cylinder layer areas provided in the plurality of first unit bands, respectively, are classified into a plurality of first areas along the longitudinal direction, an average value of thicknesses of the plurality of first areas in the radial direction is defined as a first average value, when the second cylinder layer areas provided in the plurality of second unit bands, respectively, are classified into a plurality of second areas along the longitudinal direction, an average value of thicknesses of the plurality of second areas in the radial direction is defined as a second average value, and when a size of an angle defined by the first cylinder layer area and the reference straight line is greater than a size of an angle defined by the second cylinder layer area and the reference straight line, the first average value may be greater than the second average value.

Furthermore, when one side of the dome portion in the longitudinal direction is viewed in parallel to the longitudinal direction, the plurality of helical layers may have a shape being rotation-symmetrical with respect to the reference straight line.

Furthermore, when a direction being perpendicular to the reference straight line is defined as a radial direction, an external surface of the cylinder portion includes an overlapping surface overlapping the first cylinder layer area when the cylinder portion is viewed from an external side in the radial direction, and a non-overlapping surface not overlapping the first cylinder layer area when the cylinder portion is viewed from the external side in the radial direction, and the overlapping surface has a shape surrounding the non-overlapping surface.

Furthermore, a plurality of non-overlapping surfaces may be provided, and the plurality of non-overlapping surfaces may be arranged to be spaced apart from each other while the overlapping surfaces being interposed therebetween.

Furthermore, the first helical layers and the second helical layers may define one band-type base material extending continuously.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a pressure vessel according to an exemplary embodiment of the present disclosure;

FIG. 2 is a cross-sectional view exemplarily illustrating a pressure vessel, taken in a longitudinal direction according to an exemplary embodiment of the present disclosure;

FIG. 3 is a view exemplarily illustrating one side of a pressure vessel in a radial direction according to an exemplary embodiment of the present disclosure; and

FIG. 4 is a view exemplarily illustrating one side of a pressure vessel in a longitudinal direction according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

Hereinafter, a pressure vessel 1 according to an exemplary embodiment of the present disclosure will be described with reference to the drawings.

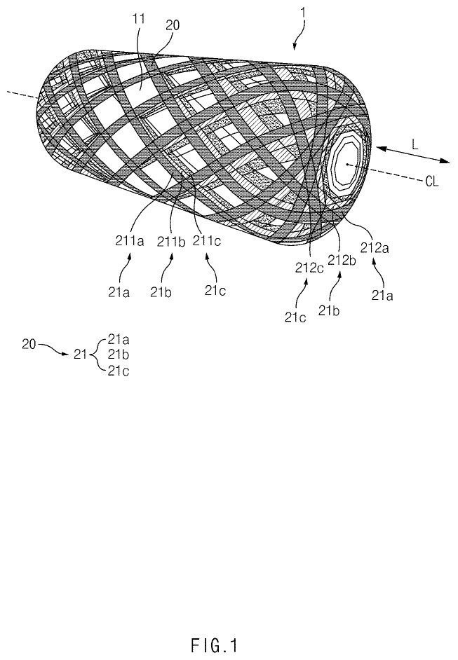

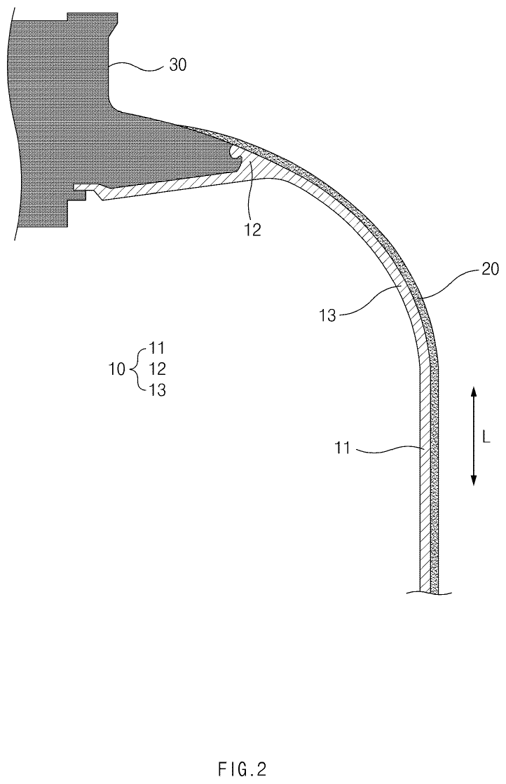

FIG. 1 is a perspective view of a pressure vessel according to an exemplary embodiment of the present disclosure, and FIG. 2 is a cross-sectional view of the pressure vessel, taken in a longitudinal direction according to an exemplary embodiment of the present disclosure.

Referring to FIG. 1 and FIG. 2, a pressure vessel 1 may be used in a means of transportation provided with a hydrogen fuel cell. A high-pressure fluid (for example, a high-pressure hydrogen gas) may be accommodated in an interior of the pressure vessel 1. Furthermore, the fluid accommodated in the interior of the pressure vessel 1 may be discharged to an outside of the pressure vessel 1. The pressure vessel 1 may include a liner 10, a composite material 20, and a nozzle 30.

An internal space for accommodating a fluid may be formed in the liner 10. The internal space may be surrounded by an internal surface of the liner 10. Furthermore, for example, the liner 10 may be formed of a plastic material. The liner 10 may include a cylinder portion 11, a dome portion 12, and a connection portion 13.

The cylinder portion 11 may define a central area of the liner 10. As an exemplary embodiment of the present disclosure, the cylinder portion 11 may have a shape of cylinder. An external surface of the cylinder portion 11 may include an overlapping surface and a non-overlapping surface.

The dome portion 12 may define a peripheral area of the liner 10. As an exemplary embodiment of the present disclosure, the dome portion 12 may have a hemispherical shape with a hole formed in a center portion thereof. A plurality of dome portions 12 may be provided. The plurality of dome portions 12 may be provided as two separate areas to be spaced apart from each other in a longitudinal direction “L” with the cylinder portion 11 being interposed therebetween. Each of these two dome portions 12 may be connected to opposite sides of the cylinder portion 11 in the longitudinal direction “L”.

The longitudinal direction “L” may mean a direction which is parallel to a height direction of a shape of cylinder, in the cylinder portion 11 having the cylindrical shape. A radial direction of the cylinder portion 11, which will be described later, may mean a direction which is perpendicular to the longitudinal direction “L”. In more detail, the radial direction may mean a direction, in which a center portion of the cylindrical shape faces a direction that a circumferential surface of the cylindrical shape in the cylinder portion 11 having the cylindrical shape.

The connection portion 13 may connect the cylinder portion 11 and the dome portion 12. As an exemplary embodiment of the present disclosure, the cylinder portion 11, the dome portion 12, and the connection portion 13 may be integrally formed with each other.

The composite material 20 may be configured to surround an external surface of the liner 10. The composite material 20 may be wound on the liner 10 through a filament winding method. The composite material 20 may include a helical layer 21 and a high-angle composite material area.

The helical layer 21 may be formed by a band-type base material which is wound on the liner 10 through a helical winding manner. The band-type base material may have a continuous string shape. As an exemplary embodiment of the present disclosure, the band-type base material may have a material, into which fibers, such as a polymer, a metal, or ceramic, are impregnated.

The helical layer 21 may include a plurality of unit bands. The unit band may have an annular shape that surrounds the cylinder portion 11, the dome portion 12, and the connection portion 13. In other words, one unit band may define one closed curve that surrounds the liner 10 once. Furthermore, a plurality of unit bands may define a portion of one continuous band-type base material. In other words, all of the plurality of unit bands may be integrally formed.

A plurality of helical layers 21 may be provided. The plurality of unit bands may define at least a portion of one continuous band-type base material.

As an exemplary embodiment of the present disclosure, when the plurality of helical layers 21 and the high-angle composite material areas are formed of the same material which is continuously connected to each other, all of the plurality of helical layers 21 may define any portion of one band-type base material, and the high-angle composite material areas may define different portions of the band-type base material.

Furthermore, when one side of the dome portion 12 in the longitudinal direction “L” is viewed in parallel to the longitudinal direction “L”, each of the helical layers 21 has a shape which is rotation-symmetrical with respect to a reference straight line CL. The reference straight line CL may be defined as an imaginary straight line that passes through a center portion of the liner 10 and is parallel to the longitudinal direction “L”.

Two arbitrary ones of the plurality of helical layers 21 may be named a first helical layer and a second helical layer, respectively. Meanwhile, in the specification, for convenience of description, it will be illustrated that two different arbitrary helical layers of the plurality of helical layers 21 are a first helical layer 21a and a second helical layer 21b illustrated in the drawing. Furthermore, for a detailed description of the present disclosure, in the specification, a third helical layer 21c which is different from the first helical layer 21a and the second helical layer 21b will also be described.

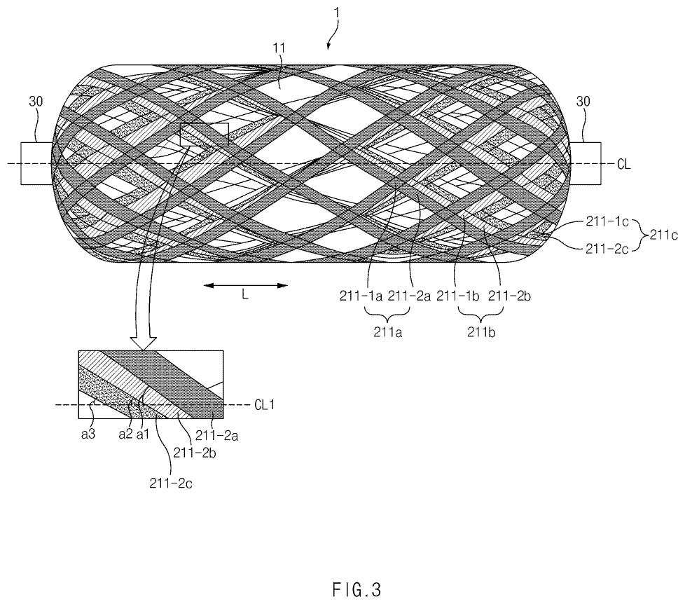

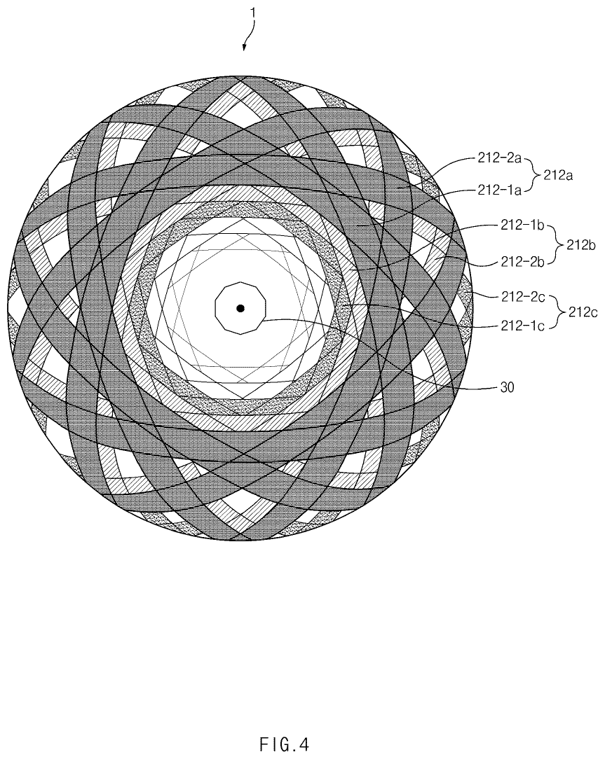

FIG. 3 is a view exemplarily illustrating a view when viewed from one side of a pressure vessel in the radial direction according to an exemplary embodiment of the present disclosure, and FIG. 4 is a view exemplarily illustrating a view viewed from one side of the pressure vessel in the longitudinal direction according to an exemplary embodiment of the present disclosure.

Referring further to FIGS. 1, 3, and 4, the plurality of helical layers 21 may include a first helical layer 21a, a second helical layer 21b, and a third helical layer 21c.

The plurality of unit bands that are provided in the first helical layer 21a may be named a plurality of first unit bands. Each of the first unit bands may include a first cylinder layer area 211a and a first dome layer area 212a.

The first cylinder layer area 211a may be defined as an area of the first unit band, which surrounds the cylinder portion 11. A size of an angle defined between the first cylinder layer area 211a and the reference straight line CL may be named a first angle a1. For example, referring to FIG. 3, the first angle a1 may mean a size of an acute angle which is an angle defined between the first reference straight line CL1 and the first cylinder layer area 211a. The first reference straight line CL1 may be understood as an arbitrary imaginary straight line which is parallel to the longitudinal direction “L” illustrated in the drawing, for convenience of description of the first angle a1, the second angle a2, and the third angle a3 that will be described later, through the partial enlarged view illustrated in FIG. 3.

Furthermore, an angle defined by the plurality of first cylinder layer areas 211a included in the plurality of first unit bands with the first reference straight line CL1 may be the same. In other words, all of the angles defined by the plurality of first cylinder layer areas 211a with the first reference straight line CL1 may be the first angle a1.

Furthermore, when the plurality of first cylinder layer areas 211a are classified into a plurality of first areas in the longitudinal direction “L”, an average value of the thicknesses of the plurality of first areas in the radial direction may be a first average value. For example, as a size of a first space which is an empty space which is surrounded by the first cylinder layer area 211a becomes greater, the first average value may become smaller, and a size of the first space becomes smaller, the first average value may become greater. As a detailed example, the first space may mean a space which is surrounded by four adjacent first extension areas 211-2a, which will be described later. The first cylinder layer area 211a may include a first cross area 211-1a and a first extension area 211-2a.

The first cross area 211-1a may mean an area of the first cylinder layer area 211a, which has a shape, in which two different first unit bands cross each other. A thickness of the first cross area 211-1a in the radial direction may correspond to a sum of the thicknesses of the two first unit bands in the radial direction. When an external side of the first cross area 211-1a faces the radial direction, the first cross area 211-1a, as an exemplary embodiment of the present disclosure, may have a diamond shape. A plurality of first cross areas 211-1a may be provided. The plurality of first cross areas 211-1a may be arranged to be spaced apart from each other.

The first extension area 211-2a may mean an area having a shape corresponding to a portion of the first unit band of one of the first cylinder layer areas 211a. For example, the thickness of the first extension area 211-2a in the radial direction may correspond to the thickness of one first unit band in the radial direction. For example, the first extension area 211-2a may be a remaining area of the first cylinder layer area 211a, except for the first cross area 211-1a.

Furthermore, the first extension area 211-2a may extend between two adjacent ones 211-1a of the plurality of first cross areas 211-1a. A plurality of first extension areas 211-2a may be provided. The plurality of first extension areas 211-2a may be arranged to be spaced apart from each other.

The first dome layer area 212a may be provided to surround an external surface of the dome portion 12. The first dome layer area 212a may extend from the first cylinder layer area 211a. As an exemplary embodiment of the present disclosure, the first dome layer area 212a and the first cylinder layer area 211a may be integrally formed with each other. Furthermore, the first dome layer area 212a may formed at any portion of the first unit band, and the first cylinder layer area 211a may be formed at the remaining portion of the first unit band.

Furthermore, a thickness of an area, in a pressing direction, of which a spacing distance between an end portion of the first dome layer area 212a in the pressing direction and an end portion of the first dome layer area 212a in an opposite pressing direction is largest, may be named a first dome thickness. The pressing direction may be defined as a direction, in which a pressure is applied to an internal surface of the dome portion 12, and the opposite pressing direction may be defined as a direction which is opposite to the pressing direction thereof.

Furthermore, a thickness of an area, in the radial direction, of which a spacing distance between one side (as an exemplary embodiment of the present disclosure, an internal side) of the first cylinder layer area 211a in the radial direction and an opposite side (as an exemplary embodiment of the present disclosure, an external side) of the first cylinder layer area 211a in the radial direction is largest, may be named a first cylinder thickness. The first dome thickness may be twice or less than the first cylinder thickness. In other words, a maximum thickness of the first cylinder layer area 211a may be twice or less than a maximum thickness of the first dome layer area 212a. The first cylinder thickness and the first dome thickness may be formed to be the same. By minimizing the first dome thickness from being excessively thicker than the first cylinder thickness, a relatively large number of unit bands may be prevented from being stacked on the dome portion 12, compared to the cylinder portion 11. The first dome layer area 212a may include a first ring area 212-1a and a first remaining area 212-2a.

The first ring area 212-1a has an annular shape that surrounds the reference straight line CL when one side of the dome portion 12 in the longitudinal direction “L” is viewed in parallel to the longitudinal direction “L”. For example, the first ring area 212-1a may have an annular shape that surrounds the reference straight line CL once. As a detailed example, the first ring area 212-1a may have a circular ring shape including a curve or a polygonal annular shape including straight lines. As a more detailed example, the first ring area 212-1a may mean an internal circumferential area (as an exemplary embodiment of the present disclosure, a decagonal shape in FIG. 4) of the first dome layer area 212a in the radial direction. Meanwhile, the idea of the present disclosure is not limited thereto, and the shape of the first ring area 212-1a may be provided in various shapes having one annular shape. The spacing distance between the first ring area 212-1a and the reference straight line CL in the radial direction may be named a first distance.

The first remaining area 212-2a may mean the remaining area of the first dome layer area 212a, except for the first ring area 212-1a. The first remaining area 212-2a may extend from the first ring area 212-1a to the external side in the radial direction. As an exemplary embodiment of the present disclosure, the first remaining area 212-2a and the first ring area 212-1a may be integrally formed with each other.

The plurality of unit bands provided in the second helical layer 21b may be named a plurality of second unit bands. Each of the second unit bands may include a second cylinder layer area 211b and a second dome layer area 212b.

The second cylinder layer area 211b may be defined as an area of the second unit band, which surrounds the cylinder portion 11. A size of an angle defined between the second cylinder layer area 211b and the reference straight line CL may be named a second angle a2. For example, referring to FIG. 3, the second angle a2 may mean a size of an acute angle which is an angle defined between the first reference straight line CL1 and the second cylinder layer area 211b. As an exemplary embodiment of the present disclosure, the second angle a2 may be smaller than the first angle a1.

Furthermore, an angle defined by the plurality of second cylinder layer areas 211b included in the plurality of second unit bands with the first reference straight line CL1 may be the same. In other words, all of the angles defined by the plurality of second cylinder layer areas 211b with the first reference straight line CL1 may be the second angle a2.

Furthermore, when the plurality of second cylinder layer areas 211b are classified into a plurality of second areas in the longitudinal direction “L”, an average value of the thicknesses of the plurality of second areas in the radial direction may be a second average value. For example, as a size of a second space which is an empty space which is surrounded by the second cylinder layer area 211b becomes greater, the second average value may become smaller, and a size of the second space becomes smaller, the second average value may become greater. As a detailed example, the second space may mean a space which is surrounded by four adjacent second extension areas 211-2b, which will be described later.

Furthermore, the first average value may be greater than the second average value. For example, when the first angle is greater than the second angle, which will be described later, the first average value may be greater than the second average value. As an exemplary embodiment of the present disclosure, when the first angle is smaller than the second angle, the first average value may be smaller than the second average value. In other words, the size relationship between the first average value and the second average value may be determined by the size relationship between the first angle and the second angle. The second cylinder layer area 211b may include a second cross area 211-1b and a second extension area 211-2b.

The second cross area 211-1b may mean an area of the second cylinder layer area 211b, which has a shape, in which two different second unit bands cross each other. A thickness of the second cross area 211-1b in the radial direction may correspond to a sum of the thicknesses of the two second unit bands in the radial direction. When an external side of the second cross area 211-1b faces the radial direction, the second cross area 211-1b, as an exemplary embodiment of the present disclosure, may have a diamond shape. A plurality of second cross areas 211-1b may be provided. The plurality of second cross areas 211-1b may be arranged to be spaced apart from each other.

The second extension area 211-2b may mean an area having a shape corresponding to a portion of the second unit band of one of the second cylinder layer areas 211a. For example, the thickness of the second extension area 211-2b in the radial direction may correspond to the thickness of one second unit band in the radial direction. As an exemplary embodiment of the present disclosure, the second extension area 211-2b may be a remaining area of the second cylinder layer area 211b, except for the second cross area 211-1b.

Furthermore, the second extension area 211-2b may extend between two adjacent ones 211-1b of the plurality of second cross areas 211-1b. A plurality of second extension areas 212-1b may be provided. The plurality of second extension areas 211-2b may be arranged to be spaced apart from each other.

The second dome layer area 212b may be provided to surround an external surface of the dome portion 12. The second dome layer area 212b may extend from the second cylinder layer area 211b. As an exemplary embodiment of the present disclosure, the second dome layer area 212b and the second cylinder layer area 211b may be integrally formed with each other. Furthermore, the second dome layer area 212b may formed at any portion of the second unit band, and the second cylinder layer area 211b may be formed at the remaining portion of the second unit band.

Furthermore, a thickness of an area, in a pressing direction, of which a spacing distance between an end portion of the second dome layer area 212b in the pressing direction and an end portion of the second dome layer area 212b in the opposite pressing direction is largest, may be named a second dome thickness.

Furthermore, a thickness of an area, in the radial direction, of which a spacing distance between one side (as an exemplary embodiment of the present disclosure, an internal side) of the second cylinder layer area 211b in the radial direction and an opposite side (as an exemplary embodiment of the present disclosure, an external side) of the second cylinder layer area 211b in the radial direction is largest, may be named a second cylinder thickness. The second dome thickness may be twice or less than the second cylinder thickness. In other words, a maximum thickness of the second cylinder layer area 211b may be twice or less than a maximum thickness of the second dome layer area 212b. The second cylinder thickness and the second dome thickness may be formed to be the same. By minimizing the second dome thickness from being excessively thicker than the second cylinder thickness, a relatively large number of unit bands may be prevented from being stacked on the dome portion 12, compared to the cylinder portion 11. The second dome layer area 212b may include a second ring area 212-1b and a second remaining area 212-2b.

The second ring area 212-1b has an annular shape that surrounds the reference straight line CL when one side of the dome portion 12 in the longitudinal direction “L” is viewed in parallel to the longitudinal direction “L”. For example, the second ring area 212-1b may have an annular shape that surrounds the reference straight line CL once. As a detailed example, the second ring area 212-1b may have a circular ring shape including a curve or a polygonal annular shape including straight lines. As a more detailed example, the second ring area 212-1b may mean an internal circumferential area (as an exemplary embodiment of the present disclosure, a decagonal shape in FIG. 4) of the first dome layer area 212a in the radial direction. Meanwhile, the idea of the present disclosure is not limited thereto, and the shape of the second ring area 212-1b may be provided in various shapes having one annular shape.

The spacing distance between the second ring area 212-1b and the reference straight line CL in the radial direction may be named a second distance. The second distance may be smaller than the first distance. The size relationship between the first distance and the second distance may be determined by the size relationship between the first angle and the second angle. For example, when the first angle is greater than the second angle, the first distance may be greater than the second distance. As an exemplary embodiment of the present disclosure, when the second angle is greater than the first angle, the second distance may be greater than the first distance. In other words, the plurality of helical layers may have different cylinder angles (sizes of the angles formed between the cylinder layer areas and the reference straight line CL) and different dome distances (spacing distances between dome layer areas and reference straight line CL in the radial direction). Furthermore, as the cylinder angle of the plurality of helical layers becomes greater, the dome distance may be formed to be greater.

The second remaining area 212-2b may mean the remaining area of the second dome layer area 212b, except for the second ring area 212-1b. The second remaining area 212-2b may extend from the second ring area 212-1b to an external side in the radial direction. As an exemplary embodiment of the present disclosure, the second remaining area 212-2b and the second ring area 212-1b may be integrally formed with each other.

The plurality of unit bands provided in the third helical layer 21c may be named a plurality of third unit bands. Each of the third unit bands may include a third cylinder layer area 211c and a third dome layer area 212c.

The third cylinder layer area 211c may be defined as an area of the third unit band, which surrounds the cylinder portion 11. A size of an angle defined between the third cylinder layer area 211c and the reference straight line CL may be named a third angle a3. For example, referring to FIG. 3, the third angle a3 may mean a size of an acute angle which is an angle defined between the first reference straight line CL1 and the third cylinder layer area 211c. As an exemplary embodiment of the present disclosure, the third angle a3 may be smaller than the second angle a2.

Furthermore, an angle defined by the plurality of third cylinder layer areas 211c included in the plurality of third unit bands with the first reference straight line CL1 may be the same. In other words, all of the angles defined by the plurality of third cylinder layer areas 211c with the first reference straight line CL1 may be the third angle a2.

Furthermore, when the plurality of third cylinder layer areas 211c are classified into a plurality of third areas in the longitudinal direction “L”, an average value of the thicknesses of the plurality of third areas in the radial direction may be a third average value. For example, as a size of a third space which is an empty space which is surrounded by the third cylinder layer area 211c becomes greater, the third average value may become smaller, and a size of the third space becomes smaller, the third average value may become greater. As a detailed example, the third space may mean a space which is surrounded by four adjacent third extension areas 211-2c, which will be described later.

Furthermore, the second average value may be greater than the third average value. For example, when the second angle is greater than the third angle, which will be described later, the second average value may be greater than the third average value. As an exemplary embodiment of the present disclosure, when the second angle is smaller than the third angle, the second average value may be smaller than the third average value. In other words, the size relationship between the second average value and the third average value may be determined by the size relationship between the second angle and the third angle. The third cylinder layer area 211c may include a third cross area 211-1c and a third extension area 211-2c.

The third cross area 211-1c may mean an area of the third cylinder layer area 211c, which has a shape, in which two different third unit bands cross each other. A thickness of the third cross area 211-1c in the radial direction may correspond to a sum of the thicknesses of the two third unit bands in the radial direction. When an external side of the third cross area 211-1c faces the radial direction, the third cross area 211-1c, as an exemplary embodiment of the present disclosure, may have a diamond shape. A plurality of third cross areas 211-1c may be provided. The plurality of third cross areas 211-1c may be arranged to be spaced apart from each other.

The third extension area 211-2c may mean an area having a shape corresponding to a portion of the third unit band of one of the third cylinder layer areas 211c. For example, the thickness of the third extension area 211-2c in the radial direction may correspond to the thickness of one third unit band in the radial direction. As an exemplary embodiment of the present disclosure, the third extension area 211-2c may be a remaining area of the third cylinder layer area 211c, except for the third cross area 211-1c.

Furthermore, the third extension area 211-2c may extend between two adjacent ones 211-1c of the plurality of third cross areas 211-1c. A plurality of third extension areas 211-2c may be provided. The plurality of third extension areas 211-2c may be arranged to be spaced apart from each other.

The third dome layer area 212c may be provided to surround an external surface of the dome portion 12. The third dome layer area 212c may extend from the third cylinder layer area 211c. As an exemplary embodiment of the present disclosure, the third dome layer area 212c and the third cylinder layer area 211c may be integrally formed with each other. Furthermore, the third dome layer area 212c may formed at any portion of the third unit band, and the third cylinder layer area 211c may be formed at the remaining portion of the third unit band.

Furthermore, a thickness of an area, in a pressing direction, of which a spacing distance between an end portion of the third dome layer area 212c in the pressing direction and an end portion of the third dome layer area 212c in the opposite pressing direction is largest, may be named a third dome thickness.

Furthermore, a thickness of an area, in the radial direction, of which a spacing distance between one side (as an exemplary embodiment of the present disclosure, an internal side) of the third cylinder layer area 211c in the radial direction and an opposite side (as an exemplary embodiment of the present disclosure, an external side) of the third cylinder layer area 211c in the radial direction is largest, may be named a third cylinder thickness.

The third dome thickness may be twice or less than the third cylinder thickness. In other words, a maximum thickness of the third cylinder layer area 211c may be twice or less than a maximum thickness of the third dome layer area 212c. The third cylinder thickness and the third dome thickness may be formed to be the same. by minimizing the third dome thickness from being excessively thicker than the third cylinder thickness, a relatively large number of unit bands may be prevented from being stacked on the dome portion 12, compared to the cylinder portion 11. The third dome layer area 212c may include a third ring area 212-1c and a third remaining area 212-2c.

The third ring area 212-1c has an annular shape that surrounds the reference straight line CL when one side of the dome portion 12 in the longitudinal direction “L” is viewed in parallel to the longitudinal direction “L”. For example, the third ring area 212-1c may have an annular shape that surrounds the reference straight line CL once. As a detailed example, the third ring area 212-1c may have a circular ring shape including a curve or a polygonal annular shape including straight lines. As a more detailed example, the third ring area 212-1c may mean an internal circumferential area (as an exemplary embodiment of the present disclosure, a decagonal shape in FIG. 4) of the first dome layer area 212a in the radial direction. Meanwhile, the idea of the present disclosure is not limited thereto, and the shape of the third ring area 212-1c may be provided in various shapes including one annular shape.

The spacing distance between the third ring area 212-1c and the reference straight line CL in the radial direction may be named a third distance. The third distance may be smaller than the second distance. In other words, the size relationship between the second distance and the third distance may be determined by the size relationship between the second angle and the third angle. For example, when the second angle is greater than the third angle, the second distance may be greater than the third distance. As an exemplary embodiment of the present disclosure, when the third angle is greater than the second angle, the third distance may be greater than the second distance. In summary, when the first angle is greater than the second angle and the second angle is greater than the third angle, the first distance may be greater than the second distance and the second distance may be greater than the third distance.

The third remaining area 212-2c may mean the remaining area of the third dome layer area 212c, except for the third ring area 212-1c. The third remaining area 212-2c may extend from the third ring area 212-1c to an external side in the radial direction. As an exemplary embodiment of the present disclosure, the third remaining area 212-2c and the third ring area 212-1c may be integrally formed with each other.

Meanwhile, in the specification, only three helical layers (the first helical layer 21a, the second helical layer 21b, and the third helical layer 21c) have been described for the plurality of helical layers 21, but this is simply for illustrative purposes, and the plurality of helical layers 21 may further include additional helical layers in addition to the three helical layers described above.

Furthermore, an external surface of the cylinder portion 11 may include an overlapping surface and a non-overlapping surface.

The overlapping surface may mean a surface that overlaps an arbitrary one of the plurality of helical layers 21 when the cylinder portion 11 is viewed from the external side in the radial direction. For example, when it is assumed that an arbitrary one of the plurality of helical layers 21 is the first helical layer 21a, the overlapping surface may overlap an area of the cylinder layer area 211a when the cylinder portion 11 is viewed from the external side in the radial direction. As a detailed example, the overlapping surface may mean an area of the external surface of the cylinder portion 11, which faces the first cylinder layer area 211a.

The non-overlapping surface may mean the remaining area of the external surface of the cylinder portion 11, except for the overlapping surface. The non-overlapping surface may mean an area that does not overlap with the first cylinder layer area 211a when the cylinder portion 11 is viewed from the external side in the radial direction. The non-overlapping surfaces may have a shape which is surrounded by overlapping surfaces.

A plurality of non-overlapping surfaces may be provided. The plurality of non-overlapping surfaces may be arranged to be spaced apart from each other. For example, the plurality of non-overlapping surfaces may be arranged to be spaced apart from each other with an overlapping surface being interposed therebetween.

The high angle composite material area may be arranged to surround the cylinder portion 11 and the connection portion 13. Furthermore, the high-angle composite material area may have a shape, in which a plurality of helical layers 21 are stacked. Furthermore, the angle defined between the high-angle composite material area and the reference straight line CL may be greater than the cylinder angle described above. The angle defined between the high angle composite material area and the reference straight line CL may be named the high-angle cylinder angle. The above-described cylinder angle may be named a low-angle cylinder angle.

Furthermore, as an exemplary embodiment of the present disclosure, the high-angle composite material area may include the same band-type base material as that of the plurality of helical layers 21. As an exemplary embodiment of the present disclosure, the high-angle composite material area may include a band-type base material which is different from one band-type base material that defines a plurality of helical layers 21, or a band-type base material which is separated therefrom.

Referring again to FIG. 2, the nozzle 30 may be disposed on one side of the liner 10 in the longitudinal direction “L”. One end portion of the nozzle 30 in the longitudinal direction “L” may have a shape that protrudes from the liner 10 to one side in the longitudinal direction “L”. The nozzle 30 may be fluidically-communicating with the internal space of the pressure vessel 1 and the outside of the pressure vessel 1. The nozzle space may guide the flow of the fluid which is introduced into the internal space from the outside thereof, and the flow of the fluid which is discharged from the internal space to the outside thereof.

The pressure vessel according to an exemplary embodiment of the present disclosure may minimize concentration of stress due to crushing of two adjacent ones of a plurality of layer and an irregular shape, and deterioration of a performance of front and rear layers.

In the above description, just because all the components forming the exemplary embodiment of the present disclosure are described as being combined or operating in combination, the present disclosure is not necessarily limited to the exemplary embodiment of the present disclosure. That is, within the scope of the purpose of the present disclosure, all of the components may operate in selective combination of one or more. Furthermore, terms such as “include,” “comprise,” or “have” described above mean that the corresponding component may be present, and thus do not exclude other components unless stated to the contrary, and rather, it should be interpreted as being able to include other components. Unless defined differently, all the terms including technical or scientific terms include the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in an exemplary embodiment of the present disclosure.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A pressure vessel comprising:
a liner configured so that a pressure is applied to an internal surface of the liner; and
a composite material surrounding an external surface of the liner,
wherein the liner includes:
a cylinder portion defining a central area of the external surface of the liner; and
a dome portion connected to opposite sides of the cylinder portion in a longitudinal direction of the pressure vessel,
wherein in a state that an imaginary straight line passing through a center portion of the liner and extending in the longitudinal direction is defined as a reference straight line,
the composite material includes a plurality of helical layers including a plurality of unit bands having an annular shape surrounding the cylinder portion and the dome portion,
two arbitrary ones of the plurality of helical layers are defined as a first helical layer and a second helical layer, respectively, and
a plurality of unit bands provided in the first helical layer are defined as a plurality of first unit bands and a plurality of unit bands provided in the second helical layer are defined as a plurality of second unit bands,
the first unit bands include a first cylinder layer area being an area surrounding the cylinder portion, and the second unit bands include a second cylinder layer area being an area surrounding the cylinder portion, and
wherein a size of an angle defined by the first cylinder layer area and the reference straight line, and a size of an angle defined by the second cylinder layer area and the reference straight line are different.

2. The pressure vessel of claim 1,
wherein sizes of angles defined by the first cylinder layer areas provided in the plurality of first unit bands, respectively, and the reference straight line are the same, and
wherein sizes of angles defined by the second cylinder layer areas provided in the plurality of second unit bands, respectively, and the reference straight line are the same.

3. The pressure vessel of claim 1, wherein the first cylinder layer areas provided in the plurality of first unit bands, respectively, include:
a first cross area having a shape, in which two different first unit bands cross each other, and
wherein in a state that a direction being perpendicular to the reference straight line is defined as a radial direction,
a thickness of the first cylinder layer area in the radial direction is less than or equal to cylinder thicknesses being thicknesses of two different first unit bands of the first cross area in the radial direction.

4. The pressure vessel of claim 3,
wherein a plurality of first cross areas are provided, and
wherein the first cylinder layer area further includes:
a first extension area extending between first and second adjacent ones of the plurality of first cross areas.

5. The pressure vessel of claim 1,
wherein each of the first unit bands further includes:
a first dome layer area surrounding an external surface of the dome portion, and
wherein the first dome layer area includes:
a first ring area, in a state that one side of the dome portion in the longitudinal direction is viewed in parallel to the longitudinal direction, having an annular shape surrounding the reference straight line.

6. The pressure vessel of claim 5,
wherein each of the second unit bands further includes:
a second dome layer area surrounding an external surface of the dome portion, and
wherein the second dome layer area includes:
a second ring area, in a state that one side of the dome portion in the longitudinal direction is viewed in parallel to the longitudinal direction, having an annular shape surrounding the reference straight line, and
wherein in a state that a direction being perpendicular to the reference straight line is defined as a radial direction, and
in a state that a size of an angle defined by the first cylinder layer area and the reference straight line is greater than a size of an angle defined by the second cylinder layer area and the reference straight line,
a spacing distance between the first ring area and the reference straight line in the radial direction is greater than a spacing distance between the second ring area and the reference straight line in the radial direction.

7. The pressure vessel of claim 5, wherein in a state that a direction, in which a pressure is applied to an internal surface of the dome portion is defined as a pressing direction, and an opposite direction to the pressing direction is defined as an opposite pressing direction,
in a state that a thickness, in the pressing direction, of an area, of which a spacing distance, in the pressing direction, between an end portion of the first dome layer area in the pressing direction and an end portion of the first dome layer area in the opposite pressing direction, is largest is defined as a first dome thickness,
in a state that a direction being perpendicular to the reference straight line is defined as a radial direction, and
in a state that a thickness, in the radial direction, of an area, of which a spacing distance, in the radial direction, between an end portion of the first cylinder layer area in the radial direction, and an end portion of the first cylinder layer area in an opposite direction to the radial direction is largest is defined as a first cylinder thickness,
the first dome thickness is less than or equal to twice the first cylinder thickness.

8. The pressure vessel of claim 5,
wherein the liner further includes:
a connection portion connecting the cylinder portion and the dome portion, and
wherein in a state that one side of the liner in the longitudinal direction is viewed in parallel to the longitudinal direction, the first ring area is located in the connection portion.

9. The pressure vessel of claim 1, wherein in a state that a direction being perpendicular to the reference straight line is defined as a radial direction,
in a state that the first cylinder layer areas provided in the plurality of first unit bands, respectively, are classified into a plurality of first areas along the longitudinal direction, an average value of thicknesses of the plurality of first areas in the radial direction is defined as a first average value,
in a state that the second cylinder layer areas provided in the plurality of second unit bands, respectively, are classified into a plurality of second areas along the longitudinal direction, an average value of thicknesses of the plurality of second areas in the radial direction is defined as a second average value, and
in a state that a size of an angle defined by the first cylinder layer area and the reference straight line is greater than a size of an angle defined by the second cylinder layer area and the reference straight line,
the first average value is greater than the second average value.

10. The pressure vessel of claim 1, wherein in a state that one side of the dome portion in the longitudinal direction is viewed in parallel to the longitudinal direction, the plurality of helical layers have a shape being rotation-symmetrical with respect to the reference straight line.

11. The pressure vessel of claim 1, wherein in a state that a direction being perpendicular to the reference straight line is defined as a radial direction,
an external surface of the cylinder portion includes:
an overlapping surface overlapping the first cylinder layer area in a state that the cylinder portion is viewed from an external side in the radial direction; and
a non-overlapping surface not overlapping the first cylinder layer area in a state that the cylinder portion is viewed from the external side in the radial direction, and
wherein the overlapping surface has a shape surrounding the non-overlapping surface.

12. The pressure vessel of claim 11,
wherein a plurality of non-overlapping surfaces are provided, and
wherein the plurality of non-overlapping surfaces are arranged to be spaced apart from each other while the overlapping surfaces being interposed therebetween.

13. The pressure vessel of claim 1, wherein the first helical layer and the second helical layer define one band-type base material extending continuously.
